(19) United States
(12) Patent Application Publication
(10) Pub. No.: US 2013/0103814 A1
(43) Pub. Date: Apr. 25, 2013

(54) System and Method for a Shared Media Experience

(71) Applicants: Elizabeth D. Carrasco, Palo Alto, CA (US); Nicolas Anthony Cavigliano, San Jose, CA (US); William Edward Reed, Bainbridge Island, WA (US); William Ryan Massie, San Francisco, CA (US); Joshua Eric Frattarola, Martinsburg, WV (US); Anton V. Jouline, Woodland Hills, CA (US)

(72) Inventors: Elizabeth D. Carrasco, Palo Alto, CA (US); Nicolas Anthony Cavigliano, San Jose, CA (US); William Edward Reed, Bainbridge Island, WA (US); William Ryan Massie, San Francisco, CA (US); Joshua Eric Frattarola, Martinsburg, WV (US); Anton V. Jouline, Woodland Hills, CA (US)

(73) Assignee: CBS Interactive Inc., San Francisco, CA (US)

(21) Appl. No.: 13/280,604

(22) Filed: Oct. 25, 2011

(51) Int. Cl. G06F 15/173; G06F 15/16

(52) U.S. Cl. 709/223; 709/231

(57) ABSTRACT

Disclosed herein are systems, methods, and non-transitory computer-readable storage media for a shared media experience. Multiple client devices are associated with a group for a shared media experience, such as watching a YouTube video together. The client devices subscribe to a publication/subscription (pub/sub) server that publishes updates for the shared media experience for the client devices. Thus, when a client device makes a change in the shared media experience, such as making a comment, pausing the video, skipping forward or backward, adjusting the volume, inserting an audio or video annotation, tagging the video, switching to a different piece of media, and so forth, the client device notifies a management server. The management server pushes that change to the pub/sub server, which publishes the change to the group. As the changes propagate to the clients, the client software modifies the client side experience accordingly.

### BACKGROUND

1. Technical Field

The principles herein relate to media consumption and more specifically to a social media consumption experience.

2. Introduction

Technology and consumer habits have demonstrated a shift of media consumption from the traditional broadcast (such as television) and physical media (such as DVD and Blu-Ray) and towards more dynamic, streaming or on-demand network-based media consumption. Some examples of network-based media consumption include services such as YouTube™, Netflix™, and Hulu™. These services often offer more convenience and flexibility over the traditional linear broadcast media.

However, some social aspects of media consumption that are found in traditional media consumption are either absent or limited in network-based media consumption. For example, in a traditional group viewing of a movie on DVD, members of the group can pause or rewind the movie, discuss portions of the movie, make comments during the movie, and so forth. If, however, each member streams the same content separately in a different location, the social aspects of the experience are lost. The group members can communicate via telephone, instant message, or other communication medium with one another, but this type of communication currently is cumbersome and limited, therefore detracting from the enjoyment of the media. Further, this type of shared communications currently are unable to recreate the full spectrum of social actions and capabilities, such as the ability to pause the movie and make a comment, replay a specific section, or skip to a section.

### SUMMARY

Additional features and advantages of various embodiments for social, shared media consumption will be set forth in the description which follows, and in part will be obvious from the description, or can be learned by practice of the herein disclosed principles. The features and advantages can be realized and obtained by means of the instruments and combinations particularly pointed out in the appended claims. These and other features will become more fully apparent from the following embodiments and appended claims, or can be learned by the practice of the principles set forth herein.

The architecture and principles set forth below enable users to enjoy a common media consumption experience in which each user's client device is synced with the others. Users can participate in the common media consumption experience via a network virtually anywhere in the world. The common media consumption experience can emulate the behaviors, abilities, and experience of the users sitting down together to watch a movie or television program, for example. However, the unique characteristics and abilities set forth herein can provide additional and enhanced functionality over the traditional face to face gathering to watch such content.

Multiple client devices are associated with a group for a shared media experience, such as watching a YouTube video together. The client devices subscribe to a publication/subscription (pub/sub) server that publishes updates for the shared media experience for the client devices. Thus, when a client device makes a change in the shared media experience, such as making a comment, pausing the video, skipping forward or backward, adjusting the volume, inserting an audio or video annotation, tagging the video, switching to a different piece of media, and so forth, the client device notifies a management server. The management server pushes that change to the pub/sub server, which publishes the change to the group. As the changes propagate to the clients, the client software modifies the client side experience of each member of the group accordingly.

In a simple example, two users are watching a video of Michael Jackson's music video ‘Thriller’, one on a laptop, and another on a smartphone. Each user logs in to a web site and joins the same group. As the users join the group, they see substantially the same video presentation at substantially the same time. When the first user clicks pause on their client device at the spot when Michael Jackson's eyes are yellow, the client device communicates that information to the management server, which notifies the pub/sub server. The pub/sub server then publishes a status, instruction, signal, or other information corresponding to the pause on the first user's client device. When the second user's client device receives that published data, it also pauses playback at substantially the same position. Then, using the same process, the second user can comment “MJ's eyes are creepy!” The second user's device sends the comment information to the management server, which in turn passes the message to the pub/sub server. When the first user's client device receives the comment information, it outputs the comment to the first user.

The client devices can be the same or different types, such as desktop or laptop computers, tablet computing devices, smartphones, personal digital assistants (PDAs), set-top boxes, smart televisions, and so forth. The client devices can connect to media presentation via the same source or different sources. The media presentation can be the exact same, such as the same YouTube video, or essentially the same, such as different Internet video feeds of the same live sporting event.

The pub/sub server can publish by push and/or pull. For example, the pub/sub server can post information at a specific network address, and the client devices check the specific network address periodically for updates. In another example, the pub/sub server can transmit information directly to the appropriate client devices when updates occur. The pub/sub server can transmit this information via AJAX style calls and/or other communication protocols.

Further, the signaling from the client devices can incorporate multiple pieces of information. The client devices can report an action, a timestamp, a position relative to the media playback, a group and/or subgroup to which the action is directed, a tag, metadata, and so forth.

In a peer-to-peer or ad hoc approach, users' devices can connect to and communicate with each other to accomplish the shared social media participation paradigm. For example, one or more client device can implement all or part of the functionality of the management server, the pub/sub server, or other network-based component. However, even in a peer-to-peer hosted embodiment, the client devices can communicate with supporting servers, for purposes such as tracking, providing user profile data, advertising, and so forth. To ensure that the system gathers metrics on what the users are doing, a server can gather data about the users' behavior in a manner that preserves users' privacy and at the same time collects additional personal data about users' likes/dislikes, and so forth anonymously and/or specifically related to the user to provide further customized services, advertising, update a social network post, adjust telecommunications availability or presence information, suggestions for other users to join to the shared media consumption experience, suggestions for additional media content to consume, and so forth.

When outputting another user's comment, for instance, the client device can modify the comment, delivery approach, and/or other aspects of the comment based on user preferences, device abilities, media type, and so forth. If the comment is a video comment, and the client device has no video output capabilities, the video comment can be converted to audio only. Conversely, if the comment is a text comment, client device preferences can indicate that the client device or other device should convert the text comment, via text-to-speech (TTS), to spoken speech in a side audio channel.

The system can link the various interactions between the clients to social networks. The system and/or individuals can create lists based on popular topics, trends, and/or personal recommendations. Users can then watch media associated with the lists in the shared viewing room. The system can examine a user's social graph to determine which social connections are registered with the system, and create lists based upon what those social connections have shared. For example, Facebook and Twitter provide APIs for gathering information indicating what a user's friends have shared, either on an individual basis or on an aggregated and/or filtered basis. The system can provide a framework to support dynamic lists. For example, a user can decide to have a channel akin to a Pandora station in which the user seeds the channel with a video, artist, genre, or a set of videos. Then the system can provide for a shared viewing experience using additional content that is either similar to the seed or that the system determines is somehow associated with the seed. The system can also leverage text analysis of the comment stream of participating users to alter or tune the seed or the video recommendation stream. Also, more generally, based upon what's been played in the room already, the system can automatically recommend or queue up additional content sharing characteristics or having overlapping or similar social graph coverage without users having to create a channel directly.

When creating a room for shared content consumption, a user can indicate a general room configuration and/or a rule set. In other words, different rooms can be configured with distinct rules. Rules can govern virtually any aspect of the room, including who can join, how many concurrent users can participate, content filters (including genres, maturity ratings, forbidden content, and so forth), comment filters, privacy, tracking, a duration of the room, voting rules, which users can control which aspects of the room, whether in-room activities are shared with social networks, content quality, skin and avatar selection, fonts, and so forth. The user interface can provide a rules menu for users to select from during the process of creating a room. Alternatively, a user can set up default rules in advance of creating a specific room. The system can adapt over time, tracking which settings a user selects for media consumption with specific groups of friends or for specific content types and suggest or automatically implement those settings or rules when the user is arranging for media consumption with the same or a similar characteristics.

The room can determine a playback order for the media based on a first-in-first-out model (queue), a first-in-last-out model (stack), or based on other more complex schemes. For example, the system can base playback order on room attendees voting on choices in the upcoming playlist or suggesting content that is not on the upcoming playlist. Further, the system can gather feedback from users regarding a currently playing piece of content, and determine whether and how often to reinsert that content into the upcoming playlist. For example, if a particular music video is universally liked by the room attendees, the system can automatically schedule that music video to appear at least once per day until the sentiment dips below a certain threshold. In yet another variation, content can be selected in a ‘round robin’ fashion based upon Video DJ's in a queue. A room can have one or more moderators who control and guide the room, including look and feel, content, and who can moderate social interactions and the room attendees. Rooms can be set up like a ‘celebrity channel’ where one user selects content without group participation. Each of these variations can be established via the rule set menu.

Any of the servers and the client devices can access social networks, such as via a social network API, to either receive information which can enhance the social media experience or to push information to the social network. For example, the pub/sub server can communicate with Facebook to identify friends of a user, fetch preferences of those friends, and make suggestions for the user's preferences based on those of his or her friends. Alternatively, the server and the client devices can coordinate to provide, via the API, an interface for a custom Facebook chat session directly in the media consumption interface and/or on other devices. The client devices can, without interacting with the server, provide a simple interface for users to post on or otherwise interact with social networks based on the social media experience. For example, if people trash talk while watching a sporting event, the system can, in a later related or similar event or even later on in the same event, spur on a discussion by throwing out the first round of trash talk to a person who is likely to get hooked and respond.

The system can record a feed of content generated by friends, which a user can come back and review by itself, or can view the feed of content as a companion channel to an associated main piece of content. The system can record analytics data regarding content consumption, and generate trends indicating popular content, popular times of day, popular channels or channel moderators, and provide that data to users in a searchable database, in a daily (or other periodic) summary, or in a direct notification, such as via email or text messaging. Trend data can be a way to attract users into participation and to ensure that the users are interested in participating further, i.e. to enhance ‘stickiness’.

The system can automatically notify a user via social media when his or her friends are sharing or consuming content. For example, the system can share on a user's Facebook wall, post to twitter, have site growl/toast messages, to let the user know when a friend is sharing content. Of course the amount of notifications may be overwhelming if every activity is reported, so the system can use familiarity thresholds to determine which events are likely to be of interest to the user.

Live event activity and interactions with close friends can bring users back to the shared content consumption platform, as well as on air broadcast when the latest episode of a TV show is online. Users can come in the room to ‘watch’ it with your friends and/or celebrities. For example, Ashton Kutcher can join a special room just for his premier episode on 2½ Men. In this way, the celebrity can interact with fans, enhance users' experience, and provide a unique edge over other non-interactive content. Client devices and/or any of the disclosed servers can generate and/or offer up recommendations for linearized video on-demand content recommendation. For example, when a user logs into the system, via a website, set top box, or other device or user interface, the system can first try to link up the viewer with other viewers with which the user has some kind of social link. The system can proactively encourage people to join the system as well by sending invites out to a bunch of friends and/or checking scheduling/calendar data or other availability information of the friends. The system can provide a notification service, so that when one user logs in and starts watching CBS Sports, Facebook friends of that user receive a notification (via SMS, email, popup, etc.) and the option to join that user. Alternatively, if a friend is unavailable to join, he can still respond with a message that the system relays to the user on behalf of the friend, such as “You know the Packers are going to lose that game, but have fun watching anyway!” Users can subscribe for notifications based on a particular event, a particular user, threshold strength of a relationship, and so forth. The system can coordinate individuals of a tight social group to all join the system at an arranged time or at least facilitate them all to be online around the same time.

Then the system can second attempt to direct the viewer toward content that the gathered social group is expected to enjoy, desire and/or interact with. The type of content that the system suggests or selects can change based on the precise mix of users that have actually joined, a viewing history, specific positive and negative user media preferences, available viewing time as a group (the selection may vary if the users only have 10 minutes together versus 3 hours), recent social media activity, and so forth.

Third, the system can try to facilitate social interactions between users by providing a clear, simple interface for users to post, comment, share, and so forth. The system can provide templates or suggestions for these interactions. Users can prepopulate the templates with their own catch phrases or personalized words as well as optional criteria for when the system should suggest those phrases. The system can monitor social interaction between the users and, if the conversation or social interactions fall into a lull, the system can inject its own commentary, social interactions, notes, factoids, etc., can change the user interface, allow the users to modify the media presentation directly, such as by providing some video overlay layer or video effect. The system can prompt users or provide suggested things to say or do in such lulls.

Fourth, the system can assist in making communications seamless. For example, if people have to come and go in the conversation because they are not available at certain times, the system can help people reintegrate into the current dialogue at a later time. Thus, users can interact with the system in real time, in a time-shifted manner, and/or in an off-line manner.

Also disclosed herein are systems, methods, and non-transitory computer-readable storage media for performing the steps by the various components of such a shared media experience architecture. In one embodiment, a management server receives data from a first client that is playing a media event streamed from a network-based source and determines an action based on the data. Then the management server propagates instructions to perform the action to a pub-sub server that distributes the instructions to a set of clients associated with the first client for execution at each of the set of clients in association with local client playback of the media event.

An exemplary pub/sub server identifies a set of clients, wherein each client of the set of clients is playing a local instance of a shared media event. The pub/sub server receives a message from a controlling server, wherein the message is generated based on data received from one of the set of clients, and publishes, based on the message, a command to control the set of clients.

In one exemplary embodiment, the system is divided into four components or functional boundaries: clients, the pub/sub server, a social facilitator, and content source(s). The clients can include many different types of devices, and can include one or more simultaneously participating client device. One user can be associated with multiple client devices at the same time, such as a cell phone and a tablet computing device, where the user views the media on the tablet and comments with other viewers via the cell phone. The pub/sub server can link users together for social interactions between users, and/or update playback of the media on the various client devices. The social facilitator can be a separate service or module that monitors users' preferences, encourages groups to form, tracks group histories, records metrics, coordinates with advertising services, and so forth. Content sources can be centralized and serve as a proxy to stream content from anywhere, or can serve as an integrator of content with new social aspects, such as by overlaying social elements over a traditional video stream coming from a user-designated source.

An example client device subscribes to a media participation group for sharing a media experience. Then the client device receives, from a server associated with the shared media participation group, information associated with input from a peer client device of the media participation group, and modifies, based on the information, a local presentation of the media experience.

### BRIEF DESCRIPTION OF THE DRAWINGS

In order to describe the manner in which the above-recited and other advantages and features of the various embodiments can be obtained, a more particular description of the embodiments briefly described above will be rendered by reference to specific embodiments thereof which are illustrated in the appended drawings. Understanding that these drawings depict only exemplary embodiments and are not therefore to be considered to be limiting of its scope, the principles herein are described and explained with additional specificity and detail through the use of the accompanying drawings in which:

FIG. 1 illustrates an example system embodiment;

FIG. 2 illustrates an example system architecture for a shared media experience;

FIG. 3 illustrates an exemplary interface for a lobby including channels for playback of media content;

FIG. 4 illustrates an exemplary user interface for shared consumption of media content;

FIG. 5 illustrates an exemplary method embodiment for sharing consumption of media content;

FIG. 6 illustrates a first example method embodiment for a management server;

FIG. 7 illustrates a second example method embodiment for a publication/subscription (pub/sub) server; and

FIG. 8 illustrates a third example method embodiment for a client device.

### DETAILED DESCRIPTION

Various embodiments are discussed in detail below. While specific implementations are discussed, it should be understood that this is done for illustration purposes only. A person skilled in the relevant art will recognize that other components and configurations may be used without parting from the spirit and scope of this document.

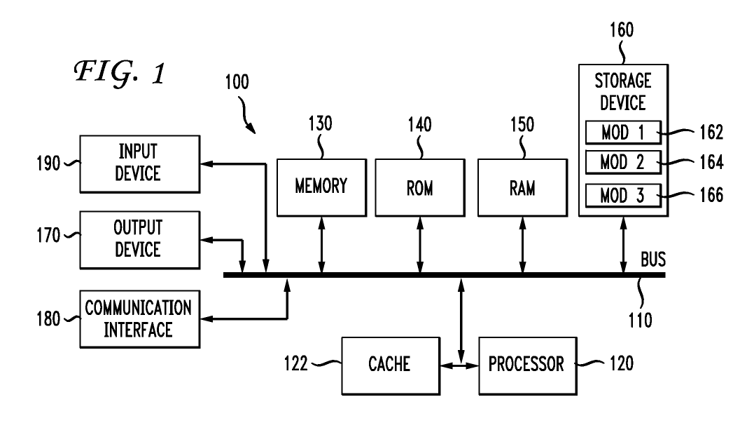

The principles herein address the need in the art for providing and enhancing a shared media consumption experience with multiple users consuming the same content at different devices and potentially in different locations. A brief introductory description of a basic general purpose system or computing device in FIG. 1 which can be employed to practice the concepts is disclosed herein. A more detailed description of architectures, user interfaces, and other aspects of shared media consumption will then follow. These and other variations shall be discussed herein as the various embodiments are set forth. The discussion now turns to FIG. 1.

With reference to FIG. 1, an exemplary system 100 includes a general-purpose computing device 100, including a processor (e.g., central processing unit (CPU) or other type of processing unit) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that these principles can be implemented on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although one of the exemplary embodiments described herein employs the hard disk 160, it should be appreciated by those skilled in the art that other types of computer readable media which can store data that are accessible by a computer, such as solid-state drives (SSD), magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod 2 164 and Mod 3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the discussion now returns to a discussion of shared media experiences across multiple client devices in different locations. As set forth above, these approaches provide for shared commenting, control, consumption, and other interactions in connection with a group of client devices all viewing or consuming a same media asset.

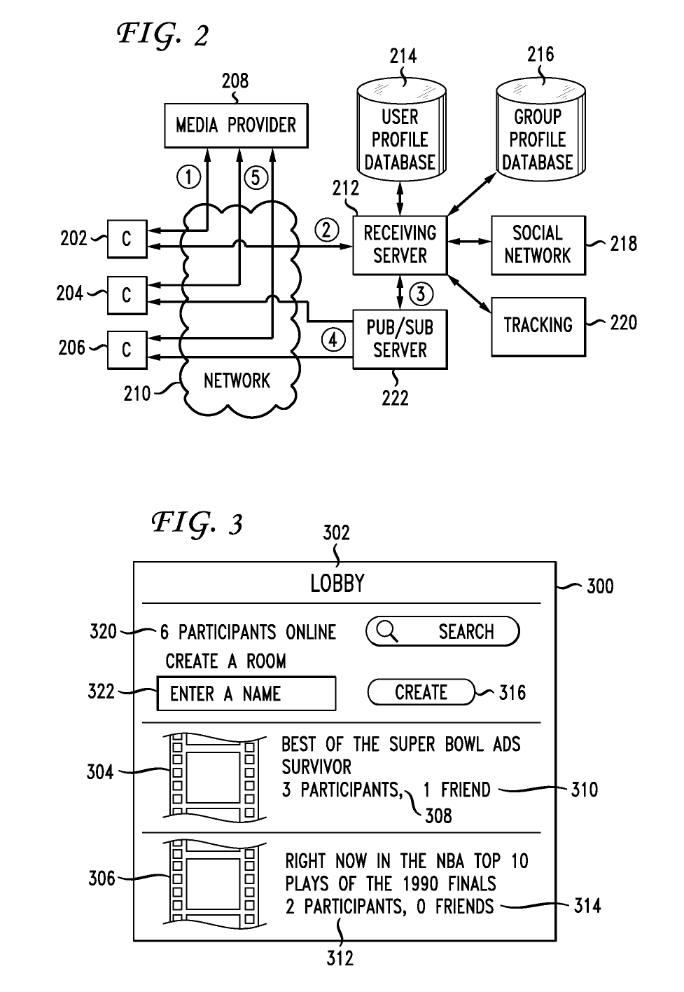

FIG. 2 illustrates an example of a system architecture 200 for a shared media experience. In this architecture 200, three clients 202, 204, 206 join a group for a shared media consumption experience administered by a management server 212 and/or a pub/sub server 222. At step 1, each of the three clients 202, 204, 206 establishes its own connection, via the network 210, with the media provider 208 and begins approximately simultaneous playback. Every event that is passed through includes two timestamps: one relative to the media time, and one relative to user time, using the pub/sub server 222. There is no guarantee that one user will be at the exact same timestamp as another user, but it will be sufficiently close that the users, who are likely remote from one another, will be unable to determine the difference without close examination. The system can allow for a buffer of a few seconds, so that the slowest connection does not spoil the experience for the entire group. The high priority on coherence of the entire group experience can tolerate some error or variance in playback synchronization. The network can be the Internet, a corporate intranet, a local area network, and/or multiple types of interconnected networks. When each client joins a group with the management server 212, the management server 212 can log information in a user profile database 214 as well as a group profile database 216. Further, the management server 212 can augment this information with data pulled from social networks 218, such as if a client 202 “likes”, tweets, or otherwise shares some portion of the media content. The management server 212 can also enhance, advertise, or invite others to join the group based on social networking data.

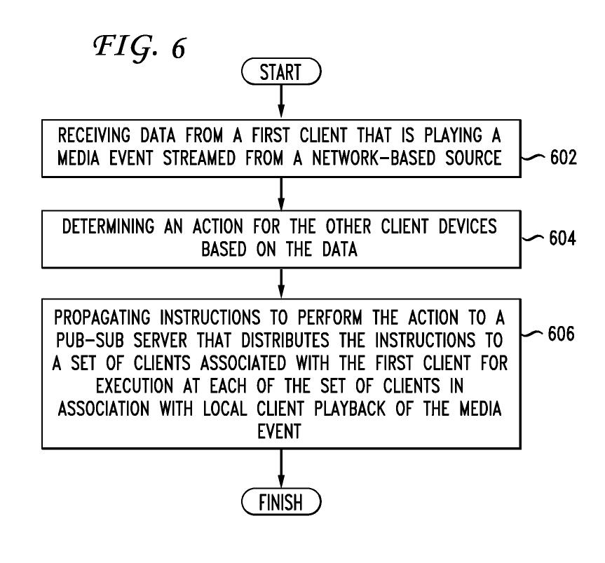

FIG. 6 illustrates a first example method embodiment for a management server. The system 100 receives data from a first client that is playing a media event streamed from a network-based source (602). The data can include a message, a group identifier, a time stamp, a client identifier, a tag, metadata, and/or other information. The data can identify a user interaction, such as a media control event, a comment event, a tagging event, a social media event, a sharing event, a video, text, or audio annotation, and so forth.

The system 100 determines an action for the other client devices based on the data (604) and propagates instructions to perform the action to a pub-sub server that distributes the instructions to a set of clients associated with the first client for execution at each of the set of clients in association with local client playback of the media event (606). The set of clients can be configured to synchronously play the media event based on a received time index into a piece of media content, or based on some other server side signaling or peer-to-peer communications. The media content does not need to be synchronized exactly, and may not even be synchronized at all, with one user viewing the content and leaving comments which later viewing users can then see. The set of clients can stream the media event from multiple different network-based sources. For example, one user can start viewing a music video on YouTube through Vevo, but due to region restrictions, a non-US user is unable to watch the music video from YouTube. Thus, that user's client device can search for a suitable domestically available alternative or the server can provide a suggested alternative to the user's client device. For example, the server can examine the original media and generate or retrieve an index of equivalents and/or backups.

The system 100 can further filter the data based on filter criteria, and propagate the instructions based on the filter criteria. For example, a certain comment may be tagged for distribution only to a commenter's immediate family members. Thus, the system can identify relationship statuses of group members and distribute the comment only to the appropriate group members. Other members may see an indication that a private comment has been sent, but the other members alternatively may not have any indication of the private comment. Users can set these receiving groups on a per-comment basis or on a per-session basis, for example. In a per-comment basis scenario, a user flags comments manually in real time, such as by selecting which users are to receive which comments. The user interface can provide different boxes for different groups of viewers so the user can send a family-friendly comment to the family group and a more edgy comment to close friends, etc.

In a per-session basis scenario, the user sets up who can see his comments for the session and later comments are distributed based on those settings. The user can configure a preference page that is created at the beginning of a session or when creating an account, for example, with the user's desired default settings. The user can then tweak settings before or during the viewing. Further, the user can modify the permissions/sharing of individual comments after they have been made. For example, if a user makes a very clever comment, and shares that comment only with his family, he may change his mind later. So the user can log in to the system, navigate to that media event, and edit the settings of that comment. Alternatively, the user can navigate to a personal comment history and edit the settings of one or more comments. Then, the user can send a link to that content to his friends, saying “check out this video and my hilarious comment at 4:28”.

In one aspect, the system can select advertisements based on the data, the instructions, personal profile information, and/or other data. The advertising presented to each client device can be different. For example, an advertising engine can more aggressively target a user who is considered to be a thought leader based on the type, quantity, and content of interactions with the media event and other users. The same signals use for personalizing the room stream can also be used for targeting advertisements based on genre, recent activity, friends in common, comment text stream term lookup, prior and current metadata, closed captioning data for understanding video context more for ad targeting, and so forth.

The user profile database 214 can store user's preferences, personal information, interaction histories, calendar events, lists of friends commonly interacted with, and so forth. The system can use the user profile database 214 to provide a smooth, pleasing, and consistent user experience. For example, if a user profile indicates that the user loves Tom Cruise, the system can join that user with others having similar interests. The group profile database 216 serves a similar function as the user profile database 214, but stores interactions of specific groups of users as an entity. For example, the chemistry between users A and B may not generate a lot of interesting commentary and social interactions for sporting events, but may trigger a heated conversation centered around political debates, whereas users A and C may both dislike politics and love to watch golf together.

The specific interactions, history, preferences, and dynamics of that group of users are unique. The system can track commonalities between groups to identify what contributes to a particular behavior. For example, if one user triggers a lively, upbeat conversation, then an advertiser may be more willing to pay a premium for those engaged participants. The group profile database 216 can provide an indication that an advertiser should pay more for groups having that type of user.

Further, groups can establish settings and other configuration options for the media, such as the volume, sound quality, interface elements or arrangement, types of accepted social interactions, etc. The group profile database 216 can store those settings so they persist from one session to another.

At step 2, the first client 202 decides to change from the original video to another video. The first client 202 transmits a signal to the management server 212. The management server 212 can process the signal to determine if the first client 202 is authorized to make such a change, determine to which groups the change applies or otherwise filter the change, how to best accomplish the change, and so forth. If the management server 212 determines that the change is allowed, then the management server 212 transmits, at step 3, a notification to the pub/sub server 222.

At step 4, the pub/sub server 222 instructs the other clients 204, 206 to change to the new video. The pub/sub server 222 does not actually change the video for the clients. Each of the clients individually reaches out, at step 5, to the media provider 208 to make the change, such as loading a different URL on YouTube or entering a different video ID into a video content management system. At any step in this process, the system can introduce advertisements to all or some of the clients. The system can ensure synchronization and/or substantial synchronization by instructing the client devices what time index from the beginning of a video to start at when joining a session, for example. Further, if the system receives reports from the client devices that indicate that the devices are not in sync, the system can introduce advertising of variable durations at the clients, for example, to allow some the client devices to resume the programming after the advertising in a synchronized manner.

If the content at the center of a social experience is only available from a subscription service, such as Netflix for example, and one of the users does not have a subscription to Netflix, the system can attempt to remedy or propose solutions to the lack of access to the content. In one embodiment, the system can detect that a user does not have the requisite permissions, subscription, access, bandwidth, digital rights management module, operating system, browser plug-in or other requirement for playing the content. In these cases, the system can provide a suggestion or solution to obtain the missing requirement, such as a one-click button to sign up for Netflix, a download link for a browser plug-in, or an enrollment page for the subscription service. In another embodiment, the system can directly stream the content to the user for a fee. In yet another embodiment, the system can user other users' permissions to gain access on behalf of the user. For example, Netflix allows a subscriber to access content on up to 6 devices. If one of the other participants has an available Netflix slot, the system can negotiate with that other participant's device or account at Netflix to temporarily, for the duration of the shared media experience, share that available slot with the user who does not have a subscription.

As the management server 212 processes client interactions between each other and with the video, the management server 212 can store tracking information in a tracking database 220. The tracking database can provide guidance for advertisements. The tracking database can also provide intelligent filtering of commentary and other clients' actions on a per-user or per-group basis. For instance, a maturity filter can sort and restrict delivery of media content and user interactions based on associated maturity, social affinity, demographic, or other ratings or criteria. The management server 212 can facilitate syncing user's content consumption. For example the management server 212 can transmit time codes to the client devices indicating where in the media content to start playback. Alternatively, each client device can start watching the video at the same point and the management server provides a cue to all of the clients to begin watching at the same time, analogous to saying “OK everybody, press play . . . NOW!”

The ratings filter can be configured manually or automatically. For example, parents and guardians can configure parental controls. Under-aged users can be required to input parental consent, via, for example, an authenticated email address, to access the site, and the parent or guardian can configure the maturity ratings. Some embodiments can also automatically configure maturity filters based on a user's age, profile, credentials, or other input.

The system can assign ratings to user interactions and/or content automatically or manually. The automatic assignment can be based on keywords, past user behavior, e.g., propensity to insert mature content, age, and so forth. In an extreme example, all user interactions can be assigned the most-mature rating by default, and the rating can be manually changed via a crowd-sourcing method, e.g., apply the rating given by the most users. A trusted source can also manually configure the maturity ratings. Users can choose to have user interactions filtered using any combinations of the filters described above.

Clients can manually approve or reject incoming changes to the media consumption experience. If client 206 does not want to go along with the change implemented by client 202, client 206 can break off from the group and continue watching the original video. Later, client 206 can rejoin the group, entering at the group's current point, which is very likely to be different from the point at which client 206 left the group. The pub/sub server can use timestamps to set the video playback time for the returning user to match the rest of the room attendees.

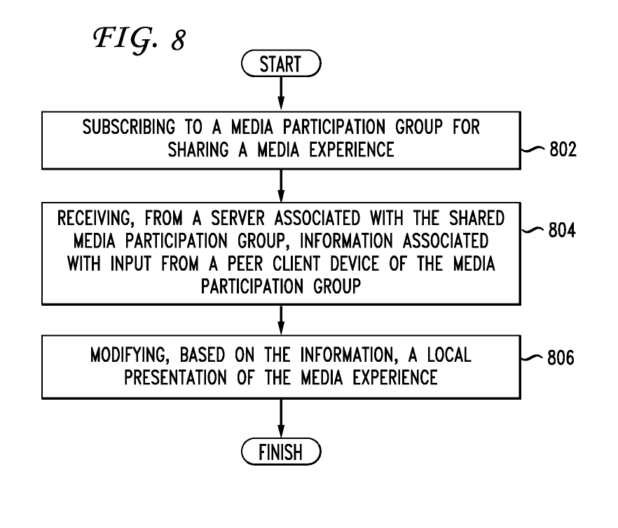

FIG. 8 illustrates a third example method embodiment for a client device. The client device subscribes to a media participation group for sharing a media experience (802), such as a network video, audio, or other media stream. The client device receives, from a server associated with the shared media participation group, information associated with input from a peer client device of the media participation group (804). The client device modifies, based on the information, a local presentation of the media experience (806). Modifying the local presentation of the media experience can include pausing playback, resuming playback, inserting a comment, inserting an animation, inserting audio, and/or tagging the media experience.

A user can subscribe to a particular group of users, a specific user, a specific piece of media content, a category of media content, time of day, etc. with the pub/sub server 222 and receive notifications, such as via email or text message, when that particular user, group of users, etc. are active. For example, a user can establish a subscription based on when at least two of his close circle of friends are viewing media together. Thus, when two or more of his friends get together to watch a movie, the pub/sub server 222 can notify the user and provide instructions on how to join. The friends can optionally include a personalized message to the user. The pub/sub server 222 can request permission from the friends before sending the notification to the user, in the event that the friends do not want the user to be aware of that particular shared media experience.

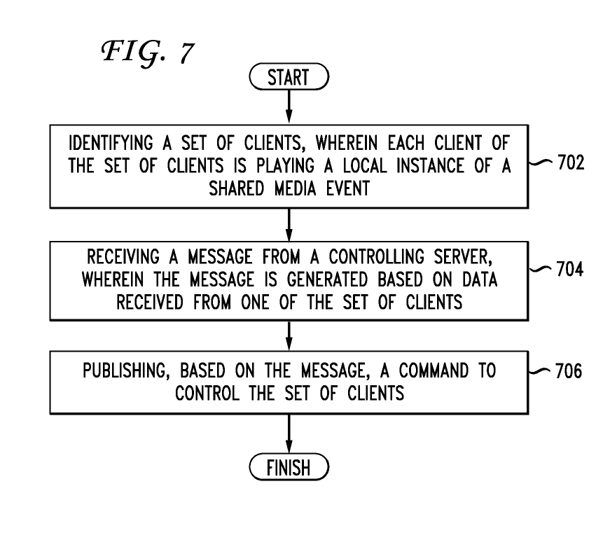

FIG. 7 illustrates a second example method embodiment for a publication/subscription (pub/sub) server. The system 100 identifies a set of clients, wherein each client of the set of clients is playing a local instance of a shared media event (702). The system 100 receives a message from a controlling server, wherein the message is generated based on data received from one of the set of clients (704). Each local instance of the shared media event can include a stream of the shared media event from a network source.

The system 100 publishes, based on the message, a command to control the set of clients (706). The system 100 can publish the command by posting the command to a network location, such as a URL, associated with the set of clients, and/or by transmitting the command to at least a subset of the set of clients. The command can instruct each of the set of clients to modify playback of a respective local instance of the shared media event. The server can sync the time code based on the player having an interface that allows the system to sync all of the clients. The system can employ a published API that client device can rely on and incorporate into their client side player. Then, the server can send a command that controls the behavior of the respective players to ensure that all of the video starts at the same time. The system can determine an approximate latency between clients, and establish synchronization differences between clients based on that approximate latency in order to help users more fluidly comment with one another.

Further, the pub/sub server, a social network, or other entity can discover and encourage different viewers to watch content at a certain time. The system can reach out to those specific viewers (identified based on demographic profiles, similar interests, similar social groups, etc.) via text message, a social networking message, email, or other notification channel. The system can encourage the other users to join the social content experience and watch the content at the same time. The system can invite others to join the group automatically based on a variety of factors including a specific advertiser's desire to get an ad out at a specific time and a specific piece of content is expected to attract the right audience. Thus, the system can encourage people to socially interact on that content at a time corresponding to the advertisement.

Thus, the social media participation experience can achieve several objectives. First, the system can continue to engage viewers in content well beyond (before and/or after as well as cross-media) when the content is first available or first aired. Second, users can interact and re-interact with the same content to provide stickiness with the content and other regular viewers consuming the same content, thereby forming a familiar and friendly community around the content. Third, the system can attract specific viewers to content at a specific time, using the content as a teaser to get user to interact. Then, the content can be further monetized through advertisements, which can be optimized by directing specific types of viewers to watch the advertisement at a specific time based upon enhancing the social interaction experience.

Certain users can participate passively in the shared media experience. In other words, these users receive updates from the pub/sub server 222 to change the media experience and view comments, for example, but they either do not wish to participate or are blocked from participation. These users can be stealth participants which are not visible or displayed to others in the shared media experience. Stealth participants can be completely invisible to others, or partially visible. In one example of a partially visible participant, the presence of the participant is made known to the others, but not a name or any other identifying information. The relationships, which can be based on information from social networks 218, between two users can dictate how much, how often, and/or what type of information is shared between them. The pub/sub server can serve as a communications hub which attempts to encourage or discourage viewers to watch or interact with media and with other users at certain times. A passive watcher can use the social interactions as its own form of entertainment. For example, people might want to watch the same content several times, but based on different groups of viewers interacting with that content and passive viewers will particularly find this interaction itself specific entertaining

The system can analyze users' behavior to determine which users are more engaged, and which are more passive. Then, the system can charge a premium for tailoring and targeting advertising to more engaged users. The more engaged users may be more likely to click, or to feel passionately about a particular topic, for example. Similarly, the system can analyze a particular user's behavior patterns to understand what excites that user, and what that user prefers. The system can attempt to engage under-engaged users by providing additional commentary in a side channel or in the main comment stream, or by suggesting alternative content or alternative channels to join.

One way to engage users is to enhance the social content consumption experience with games or with a credit earning program. For example, users can earn credits for watching others' videos, for watching in a large group, or for posting videos that attract other viewers. Then these points can be used in games, to establish or maintain reputation, and so forth. Users can earn variable credit based on the conditions of the channel or room, or based on their level of engagement in the room. For example, a room with more friends or with a smaller but closer set of friends can earn a higher amount of points as opposed to watching content alone. A user who is engaged, commenting and interacting with others, can earn more points than a user who is passively watching with little interactions with others.

One specific use case is annotating a media event such as a sporting event. The system can overlay user-generated content from “experts” on top of sports content that would allow non-experts to further appreciate the game in different ways. This can occur in real-time or after the initial broadcast, perhaps encouraging repeat viewings of the content. For example, in one instance the sports content could be overlaid with comments from the very same players who just played the game who are later commenting on their game providing viewers different perspectives on the game, which could serve a similar function to DVD directory commentary audio tracks, but for broadcast/streamed media.

Coaches could overlay comments for instructing others who want to learn strategy, etc. around specific plays. Players, fans, and others could learn what the coaches were thinking and how the plays were effective. Commentators can overlay commentary on the sporting event that also would provide such insight, such as for fantasy sports. For instance, a user can trash talk by aggregating sports clips together, via the system, that mirror the fantasy sport play by play with the fantasy owners commenting on the event and/or a fantasy commentator. These principles can be applied in a more generalized ‘instruction’ or ‘critique’ use case set. A teacher can use this type of application to teach and remotely review and instruct in subjects such as dancing, drawing, musical performances, public speaking, etc. This platform can also be used as a collaborative instructional tool set for real-time class participation. The video stream can be live, and the remote/distributed students can use the comment stream to ask questions about the classroom material. Then, the teacher can pause the live video stream, switch to a webcam feed to provide instruction or answer questions, etc. Afterwards, the teacher can unpause the live video stream, achieving similar functionality to a digital video recorder (DVR), but in a shared environment. The teacher can pause the video stream to inject questions such as part of a pop-quiz to ensure that students are attentive, or as part of a poll. This system can also provide a guided tour of a game, in which individuals record their in-game activity, and later replay that activity to walk through it with their friends, to explain strategies, brag, or to show secret tips. Similarly, expert referees, such as boxing referees, can use this approach to remotely referee a boxing match from different locations. Referees can then review multiple different angles, pause, rewind, and review, and discuss in real time with other expert referees how many points should be awarded or whether a particular move was legal or not. As an added bonus, fans of the boxing match can view the back and forth between the referees and provide a secondary level of commentary which the referees can optionally view. This audience participation can influence the thinking and opinions of the referees. In another use case, directors can use the system to add commentary to video material they have produced.

The discussion now turns to several exemplary user interfaces for a web portal for shared media consumption. FIG. 3 illustrates an exemplary interface for a lobby including channels for playback of media content. A lobby is an optional portal through which users can browse, search, filter, and join shared media experiences. Users can browse to a web site, log in with their username and password, and then enter the lobby. In the lobby, users can view previews of media content, chat with other users, see which users are online, how many users are in a particular group, where their friends are, and so forth. The lobby can list past, current, and scheduled or other future media content, even if no users are in a group actively participating in that content. Users can plan and coordinate their viewing experience with others. The system can prioritize how media content is presented for each user in order to anticipate which groups or which content would be of the most interest to the user. For example, if the user likes smaller groups, the system can present groups with 2-4 members at top. If the user likes sci-fi with lots of geeky commentary, the system can present groups of 6 or more currently viewing sci-fi at top.

The interface can display a lobby 302 in a web browser 300. A user can use lobby 302 to browse one or more channels 304, 306 of media content. The channels can be presented as recommendations based on a user profile, most-watched channels, random channels, etc. In this example, the channels are videos labeled “Best of Super Bowl Ads” (304) and “Right Now in the NBA” (306). Channels can be previously recorded or live. A number of users 308, 312 can be displayed for each channel, along with a number of friends viewing the channel 310, 314. An option to create a channel, or some persistent group experience that is not limited to a particular piece of media, such as a create button 316 and field 318, can also be provided. The group experience can persist beyond specific user's participation, such that when all the users leave the channel, the channel remains or persists and can be resumed in essentially the same condition as it was last used. A channel can transcend a particular piece of media, and can serve as a ‘hangout’ for a particular revolving group of users. Thus, the users are logging in to the ‘channel’ for the group, which is not tied to any particular content category, type, event, etc. Users join the channel in order to participate with at least a subset of familiar, regular users. To create a channel, a user can identify content to be associated with the channel. For example, a user can insert a link to a video or link to a website containing a video into field 318 and click button 316. A total number of users 320 receiving media content via channels can be displayed, and a search bar 322 can be included to search for media content, users, friends, channels, and so forth.

The lobby and/or specific channels can interface with interactive guides to recommend specific linearized viewing experiences, such as showing a guide of channels in an order that promotes different social groups to watch the video at that time. For example, Joe get home from work at 7 pm, spends time with his family, and then turns on the television at 9 pm. The interactive guide will show Joe 3 times slots, 9-10 pm, 10-11 pm and 11-12 pm with a specific show and perhaps who else will be watching the show at that same time, including those who were invited and haven't responded yet and those who have accepted, and can even show a list of those who have declined or are tentatively attending. Joe can then make a more informed decision whether to accept the 9-10 pm time slot or the 10-11 pm time slit as something he wants to watch or not. If Joe doesn't choose one of those options, the system can present another suggestion for that time slot. The system can present multiple channels based on genre, social groups, etc. with this same paradigm and Joe chooses out of each channel which programs he wants to watch. The system could then create an aggregate channel (e.g., “Joe's evening channel”) that shows all of the programs Joe has chosen from the various channels and who's going to be watching it with him.

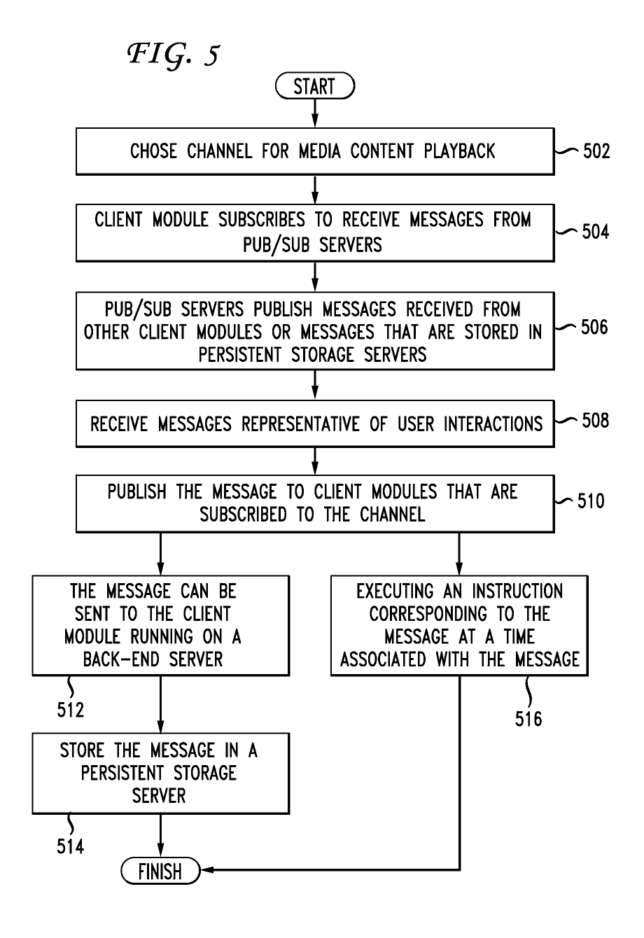

Having disclosed some basic system components and concepts of embodiments of the invention, the discussion now turns to the exemplary method embodiments shown in FIG. 5. For the sake of clarity, the various methods are discussed in terms of an exemplary system 100 as shown in FIG. 1 configured to practice the respective methods. The steps outlined herein are exemplary and can be implemented in any combination thereof, including combinations that exclude, add, or modify certain steps.

FIG. 5 illustrates an exemplary method embodiment for sharing consumption of media content. A system practicing this method first chooses a channel for media content playback (502). The client module subscribes to receive messages from the pub/sub servers (504). The pub/sub servers publish messages received from client modules and/or messages that are stored in persistent storage servers to other client modules (506). The user can input user interactions, resulting in messages being generated to gateway and/or to pub/sub servers (508). The messages can include a media time or channel time, and/or be associated with a time sent in a separate message. Then, the pub/sub servers can publish the message to other client modules that are subscribed to the channel and who have not filtered this particular message (510). In one embodiment, one of the client modules subscribed to the channel is running on one of back-end servers to monitor user interactions. The message can be sent to the client module running on a back-end server (512), which can then store the message in a persistent storage server (514). Similarly, other client modules can execute the instruction corresponding to the message at a time associated with the message (516).

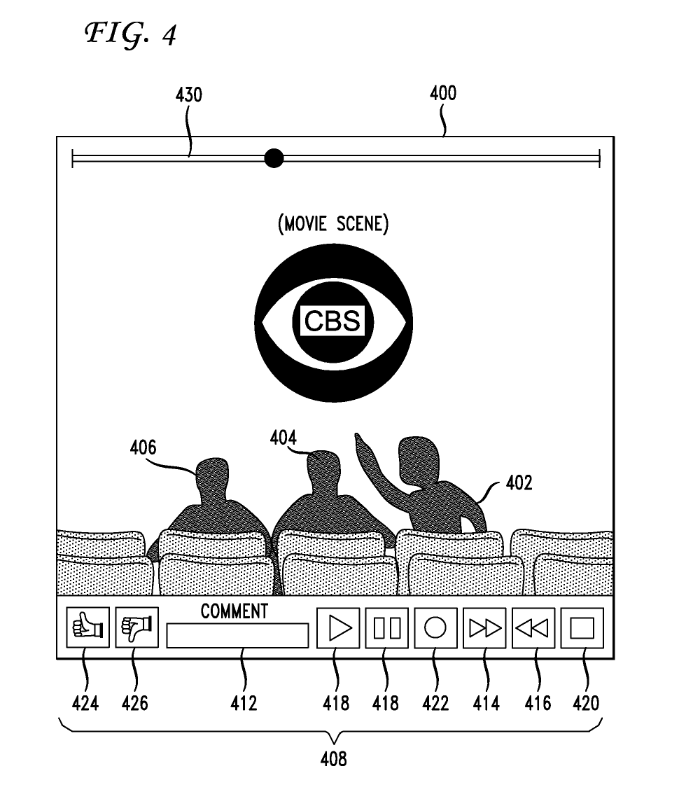

FIG. 4 illustrates an exemplary user interface for a group to share in experiencing media content. Users can select from the lobby a channel or group to join for playback, which can lead to the channel being presented in the group 400 as illustrated in FIG. 4. In this example, group 400 is presented in a movie theater theme, but other themes are possible, e.g., living room, outdoor park, concert hall, and so forth. The themes can be based on the type of content being watched, user preferences, user locations, group input, holidays, calendar events, time of day, and so forth. Presentation of group features, such as control panel 408, can vary depending upon the theme. The group 400 can include users who can be displayed using avatars 402, 404, 406 sitting in movie theater chairs. The users can also be friends in a social network supported by a social networking service. Users can join the group without any restrictions, or the groups can be closed, i.e. ‘by invitation only’. A group creator or administrator can establish these settings. Alternatively, users can vote for these settings, or they can be established by any user.

The group 400 also can present a control panel 408, which can include controls for functions such as rewind 416, play/pause 418, stop 420, record 422, fast-forward 424, and so forth. Control panel 408 can also include a progress bar 430 that identifies the progress of playback, and can be used to rewind or fast-forward. A comment field 412 can also be included for insertion of comments. Comments can optionally be made via audio, or via thumbs up/thumbs down buttons, too. Additionally, comments can have independent thumbs up/thumbs down buttons 424, 426. Permission to insert comments and control playback can be given to all users or to a moderator. For example, a group of friends may want to allow everyone to comment and control playback, but if random members of the public are receiving media content, then a pre-selected user can be selected as a moderator for controlling and commenting on the media content. This could be helpful if, for example, a director is viewing a video and users want to get the director's commentary on the video. In other embodiments, mute buttons, not illustrated, can be presented to mute user interactions or comments from particular users. The moderator can also be a video or disk jockey and can select media content for playback. The moderator can appear differently, e.g., highlighted to signify who is the moderator. Users can also optionally be identified with user names.

User votes, likes, up-ranks, etc. can allow certain people to have permissions to moderate, change the channel, invite others, kick or ban certain users, set standards for comments (i.e. no swearing or other offensive language, etc.). A person's social reputation/ranking, if sufficiently high, can result in that person receiving to the ability to moderate or comment. Users can earn points my commenting, meta-commenting, moderating, ranking others' comments, and so forth. For example, moderators earn more points than people just commenting who earn points and viewers perhaps get no points, or have to give a certain number of points to the people commenting. Viewers can vote on whose comments are funnier, more informative, relevant, or more enjoyable. Then the system can split a pot of points among users with the most votes. This would make watching, commenting and reading comments into a sort of game that keeps everyone including the passive watchers more engaged. The user with the most points at the end of the content can select the next piece of content, for example.

The record button 422 of control panel 408 can allow a user to capture viewed user interactions. The user interactions can be captured locally or captured by a client module running on a backend server. The captured user interactions can be stored on a persistent storage server and recalled for later playback either locally or by other client modules requesting user interactions. The stored user interactions can be recalled, for example, via a permanent hyperlink, or can be searched based on channel or original broadcast time of the media content being played back. Stored user interactions can then be replayed, along with associated media content, at a later time, during which time, additional users can provide further comments on the content and/or the previously created comments. The system can provide a notification to the author and/or original participants associated with of an original comment when another user makes a later comment related to the original comment. This feature can provide a vehicle for people to reengage with the same comment they just finished commenting on at a later date.

The system can assign a user-established or automatically-set expiration date to comments so that when people comment on the content, if they don't continue commenting at some regular interval or frequency their past comments go away. This can incentivize users to comment more regularly on content. Often a set of users will have a conversation that spans multiple different times and pieces of media content. The system can maintain a threaded approach which preserves comment-based conversations across media, times, and different social media sessions. Thus, as two familiar users interact with each other, the system can present at least part of a previous conversation made a week earlier while watching a different video.

The system can incorporate or generate certain gaming elements, e.g., karma scores, badges, ranks, and so forth, which can lead to rewards such as points, better avatars, new themes, accessories, access to premium content, cash, or prizes. Karma can identify how much positive/negative feedback a user has given or received. Badges can be given for number of comments, amount of media content viewed or number of hours of media content playback, time of day that media content is viewed, number of consecutive days media content is played back, and other metrics. In order to encourage group participation, groups as well as individuals can earn karma, badges, etc. Ranks can be dependent on the number of badges, karma, or points a viewer has. Finally, the system can distribute rewards based on any combination of rank, badges, or karma. Advertisers can provide certain rewards based on behavior within a specific time frame to encourage viewing of promotional media content.

The system can analyze the content, and generate trivia questions about the content. Alternatively, a human user, who can be a participant in the group or not, generates trivia questions manually. Then, the system can insert the trivia questions into the social experience. Users who correctly answer the trivia question can earn extra ‘fan points’ showing that they are truly paying attention to details of the show. The system can award a first user to provide the correct answer, or every user who provides a correct answer. Thus, responses to the trivia questions may be shown to the entire group, or can be hidden to the group and only made known to the server.

In a similar vein, users can predict what will happen in a given episode. The earlier a user submits a correct prediction, the more points the system can award to that user. Then, writers can gain insight into how early their audiences clued in to specific hints, elements, and/or foreshadowing in the show. Similarly, content producers can insert polls into the social experience asking what a specific group or demographic thinks will or should happen next. Then the content producers can guide following episodes or sequels based on answers to those polls.

Not only can users comment on the shared social experience of the primary media content, but users can also comment on advertising content. Advertisers can pay a fee to obtain the advertising comments to determine if the advertising was successful, memorable, funny, or achieved whatever else the advertising was intended to do. If the users are busy commenting with each other about the primary media content during the commercials, then the commercials may not have been particularly engaging. These approaches can be accomplished not only on a single client platform, but in a cross platform way, including, for example, set top boxes, gaming consoles, mobile device such as tablets or smartphones, multiple devices associated with a single user, desktop and laptop computers, and so forth. The specific subsets of functionality available for a user can be based on the capabilities of the client platform software and/or hardware as well as based on a subscription level. For example, a premium subscriber may have more or easier access to features that a free subscriber does not.

While these principles are applicable to consumption of content generally, “viewing of video content,” “playback of media content,” and variations thereof are used in place of “consumption of media content” for simplicity of explanation. As further examples, “consumption of media content” can also include listening to audio (live or recorded), viewing photographs, participating in interactive games, interactive web sites, electronic books (audio/text), and so forth.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be implemented as a web page, a mobile device app, or other local or network hosted software package. Beyond providing a shared media content experience for entertainment, this approach can be applied to research. For example, content providers often use focus groups to evaluate media content. Focus groups can be difficult or costly to arrange because they require people to travel to a location to share media content under controlled circumstances. Focus groups can meet more efficiently by viewing, interacting with, and commenting on media content from remote locations, as set forth above, thus enabling easier and cheaper participation. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving data from a first client that is playing a media event streamed from a network-based source;
determining an action based on the data; and
transmitting instructions to perform the action to a pub-sub server that distributes the instructions to a plurality of clients associated with the first client for execution at each of the plurality of clients in association with local client playback of the media event.

2. The method of claim 1, wherein the data comprises at least one of a message, a group identifier, a time stamp, and a client identifier.

3. The method of claim 1, further comprising filtering the data based on filter criteria.

4. The method of claim 3, further comprising propagating the instructions based on the filter criteria.

5. The method of claim 1, wherein the plurality of clients are configured to synchronously play the media event.

6. The method of claim 5, wherein each of the plurality of clients streams the media event from a plurality of network-based sources.

7. The method of claim 1, wherein the data identifies a user interaction.

8. The method of claim 7, wherein the user interaction comprises a comment.

9. The method of claim 1, wherein the instructions are associated with an advertisement.

10. The method of claim 9, wherein the advertisement is targeted to a specific client.

11. A system comprising:
a processor;
a memory storing instructions for controlling the processor to perform steps comprising:
identifying a plurality of clients, wherein each client of the plurality of clients is playing a local instance of a shared media event;
receiving a message from a controlling server, wherein the message is generated based on data received from one of the plurality of clients; and
based on the message, publishing a command to control the plurality of clients.

12. The system of claim 11, wherein each of the plurality of clients plays a respective local instance of the shared media event substantially synchronously with others of the plurality of clients.

13. The system of claim 11, wherein the command is published via posting the command to a network location associated with the plurality of clients.

14. The system of claim 11, wherein the command is published via transmitting the command to at least a subset of the plurality of clients.

15. The system of claim 11, wherein the command instructs each of the plurality of clients to modify playback of a respective local instance of the shared media event.

16. The system of claim 11, wherein each local instance of the shared media event comprises a stream of the shared media event from a network source.

17. A non-transitory computer-readable storage medium storing instructions which, when executed by a computing device, cause the computing device to perform steps comprising:
subscribing, at a client device, to a media participation group for sharing a media experience;
receiving, from a server associated with the shared media participation group, information associated with input from a peer client device of the media participation group; and
based on the information, modifying, at the client device, a local presentation of the media experience.

18. The non-transitory computer-readable storage medium of claim 17, wherein the shared media experience is a network stream.

19. The non-transitory computer-readable storage medium of claim 17, wherein the network stream is from a first source which is different than a second source used by at least one other client device.

20. The non-transitory computer-readable storage medium of claim 17, wherein modifying the local presentation of the media experience comprises at least one of pausing playback, resuming playback, inserting a comment, inserting an animation, inserting audio, and tagging the media experience.
